(19) United States
(12) Patent Application Publication
(10) Pub. No.: US 2009/0322409 A1
(43) Pub. Date: Dec. 31, 2009

(54) Power reduction apparatus and method

(76) Inventors: Maxim Levit, Binyamina (IL); Efraim Rotem, Haifa (IL)

Correspondence Address: INTEL CORPORATION;c/o CPA Global, P.O. BOX 52050, MINNEAPOLIS, MN, 55402, US

(21) Appl. No.: 12/215,289

(22) Filed: Jun. 26, 2008

(51) Int. Cl. G05F 1/567

(52) U.S. Cl. 327/513

(57) ABSTRACT

Provided is an approach to saving active power through lowering a supply voltage when operating temperature goes up, while substantially maintaining operating performance.

### BACKGROUND

This relates generally to power reduction and in particular, to active power reduction in integrated circuit (IC) chips supplied with relatively low voltages.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an exemplary graph showing Fmax vs. temperature relationships for a processor unit supplied at different voltage levels.

FIG. 2 is a block diagram showing a circuit to reduce active power in a functional circuit in accordance with some embodiments.

FIG. 3 is a graph showing an exemplary Vcc/T relationship for a circuit at a given performance requirement.

FIG. 4 is a diagram showing a routine for implementing the circuit of FIG. 2 to reduce active power in accordance with some embodiments.

FIG. 5 is a graph showing an exemplary range of suitable Vcc/T relationships over different performance requirements in accordance with some embodiments.

FIG. 6 is a diagram showing a circuit to reduce active power in a processor in accordance with some embodiments.

FIG. 7 is a diagram showing a routine for implementing the circuit of FIG. 6 to reduce active power in accordance with some embodiments.

FIG. 8 is a block diagram of a computer system having a circuit to reduce active power in accordance with some embodiments.

### DETAILED DESCRIPTION

Some embodiments disclosed herein are based on the appreciation and utilization of a phenomenon of temperature/conduction inversion with metal oxide semiconductor (MOS) transistors. Transistor temperature/conduction inversion is a phenomenon of increasing, rather than decreasing, transistor strength (channel conduction, at least in saturation mode) with increasing temperature when a sufficiently small supply (Vcc) is used. In other words, as device temperature increases, transistor operating voltage can be reduced. Device power, which is proportional to the square of its applied voltage, can thus be significantly reduced by reducing the supplied voltage by a relatively small amount. As power is reduced, the device temperature goes down, resulting in device power reducing even more due to lower leakage power. (Leakage power is a strong function of temperature, the higher the temperature the higher the leakage power. Note, however, that as temperature goes down, the transistor's strength decreases, as well, so that the supply voltage may have to be increased, albeit not necessarily to the level from which it was reduced.)

Normally, when a transistor's supply is relatively large (e.g., greater than 1.5 V), the transistor strength decreases as operating temperature increases. However, when smaller supplies are used, especially with smaller transistors (e.g., 90 nM processes or smaller), transistor strength actually increases as the operating temperature increases.

Two transistor characteristics primarily influence transistor strength: carrier mobility and transistor threshold voltage, V_{T}. The higher the mobility and the lower the threshold voltage, the higher is the transistor strength. Increasing temperature generally decreases mobility (weakening a transistor) but it also lowers threshold voltage (strengthening the transistor). Thus, as temperature goes up or down, these two transistor strength characteristics oppose one another. For past MOS transistor technologies (e.g., transistors formed using 90 nM or larger processes with supply voltages greater than 1 V) carrier mobility degradation tended to dominate voltage threshold changes, and so transistor strength generally decreased with increasing temperature. As a result, the lowest tolerable operating voltage (minimum Vcc for simplicity) to achieve a given performance level was dictated by a transistor's speed at worst case operating temperatures. That is, to achieve an acceptable performance (e.g., operating frequency), a minimum allowed Vcc would have to be higher for higher operating temperatures.

It is observed, however, that with sufficiently small transistor sizes (e.g., 90 nM processes or smaller) combined with operating voltage reduction (especially below 1V), the situation changes. Transistor voltage threshold (V_{T}) is reduced with temperature increase so strongly that it dominates over mobility degradation, and as a result, transistor strength increases with an increase in temperature.

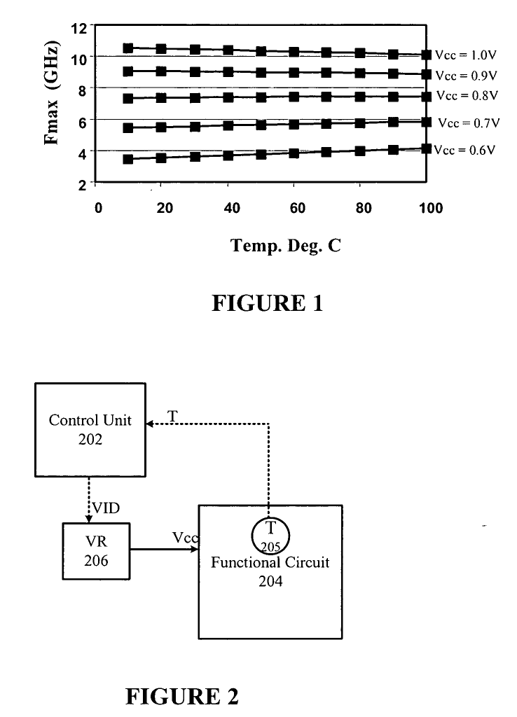

FIG. 1 shows a graph of Fmax versus temperature curves measured for a functioning processor core made using a 45 nM MOS transistor process. The different curves show Fmax/Temp. relationships with the core (or at least processing circuits in the core) supplied with different voltage levels ranging from 0.6V to 1.0V. The term “Fmax” is the maximum operating frequency that was reliably attainable for the processing core during the testing used to generate these curves. Attainable frequency is directly proportional to transistor strength at saturation, so these curves do in fact indicate that transistor strengths, at least over a range of temperatures, increase with increasing temperature. As shown in these curves, the “strengthening” is especially pronounced for logic powered with lower supply voltages.

FIG. 2 is a block diagram of a circuit for reducing active power for a given frequency using the temperature/conduction inversion phenomena. This circuit comprises a control unit 202, functional circuit 204, and voltage regulator (VR) 206, coupled together as shown. The control unit 202 serves to control the VR 206, for example by way of a voltage identification (VID) signals, to supply the functional circuit 204 with a supply voltage (Vcc). (Other control methods are certainly possible and will depend, among other things, on the utilized voltage regulator and/or control unit.)

The functional circuit 204 can be any logic circuit or system of circuits such as a core in a processor, a graphics processing unit, or any other functional logic block implemented in a processor, portable digital device, cell phone, or any other amenable device.

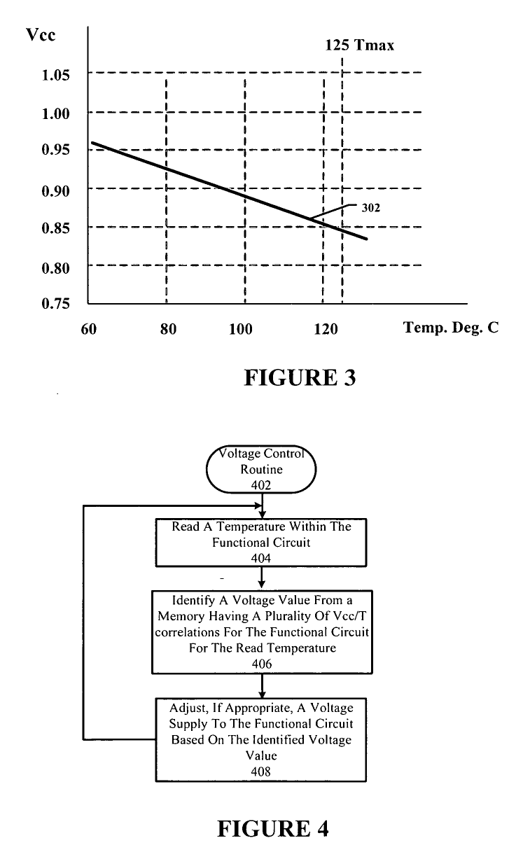

The functional circuit 204 has one or more temperature sensors to provide to controller a temperature signal (T) that is indicative of a temperature within a part of or throughout the functional circuit 204. In some embodiments, it controls the supply voltage Vcc in accordance with a curve such as the Vcc/T curve shown in FIG. 3. The curve in this example is for a single frequency. This curve may affectively be “shifted” by the control unit 202 upward or downward, depending on the performance (e.g., frequency) required for the functional circuit. If higher performance is required, the curve would be shifted upward, and if less performance is required, than it would be shifted downward. For a given performance level, as the temperature (T) in the functional circuit increases, the control unit 202 controls the VR to reduce Vcc. Likewise, if the circuit's temperature goes down, the supply voltage is increased. The example in FIG. 3 shows a linear function. It is understood, however, that other functions can also be applied. Another example would be a “digitized” function where one or more discrete temperature points are associated with set of frequencies.

The control unit 202, VR 206, and functional circuit 204 can be implemented with any suitable combination of circuit elements, components, modules, and/or software instructions. They may be in separate chips or implemented in one or more common chips. For example, in some embodiments, the functional circuit and control unit could be on a common processor or system-on-chip (SOC) chip, with the VR implemented in a separate chip or as a circuit on the common processor/SOC chip.

FIG. 4 shows a routine 402 that may be implemented by control unit 202. This routine could be implemented as executable soft or firm ware instructions within the control unit, or it could be implemented wholly or partially using dedicated logic and/or other circuit components.

At 404, the control unit reads a temperature from the functional unit. This may be an actual temperature value, or alternatively, it could be a signal value correlating to a temperature reading within the functional circuit.

At 406, the control unit identifies a Vcc value corresponding to the read temperature for the functional circuit. For example, it could retrieve this from a look-up table in memory (e.g., memory within or outside of the control unit) or it could calculate it using pre-programmed equation constants. In some embodiments, physical operating parameters, e.g., measured during a manufacturing process, could be burned or programmed into memory when the control unit is made or otherwise prepared for distribution. For example, the parameters could correspond to one or more Vcc/T curves such as the one shown in FIG. 3. In other embodiments, some physical parameters, like transistor frequency can be measured by special circuitry, like a ring oscillator for example, within processor 603, and then could be used for selecting a Vcc/T curve by the control unit 406.

At 406, the control unit adjusts, if appropriate, the Vcc provided by the VR. That is, it changes the VID from the previous command if the temperature has changed sufficiently to warrant an update to the supplied Vcc. Depending on design considerations, some type of hysteresis could be employed for stability benefits or the like.

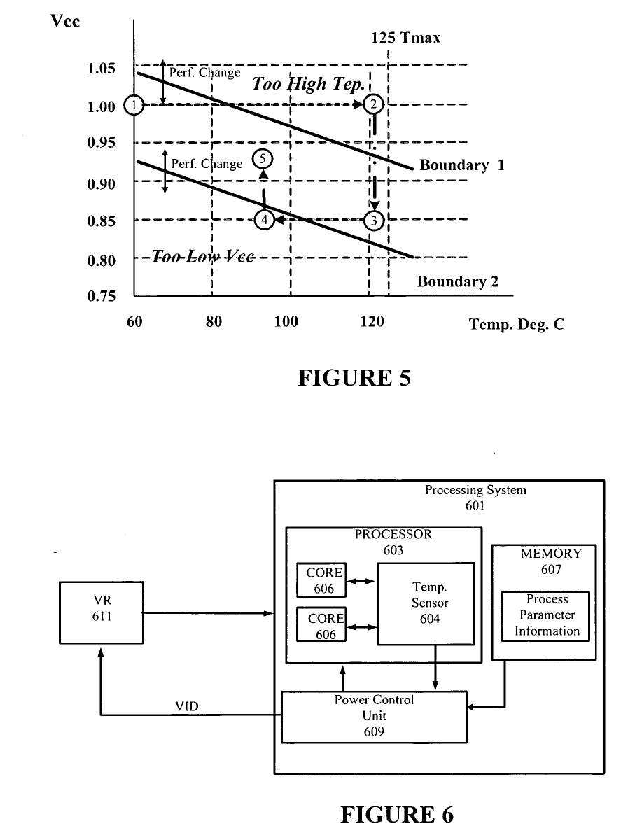

FIG. 5 shows a graph with first and second boundary Vcc/T curves (Boundary 1, Boundary 2) to delineate an acceptable Vcc/T range of operation for a functional circuit. These boundaries illustrate the use of an operating range (with realistic tolerances), as opposed to controlling to a “tight” Vcc/T curve. In this graph, arrows indicate that the curves may be raised or lowered, respectively, for more or less performance requirements from the functional circuit.

The graph demonstrates how a controller could adjust Vcc as the operating temperature changes to reduce active power but maintain acceptable performance. It also shows, with the numbered points of exemplary control progression, how the Vcc and temperature may iteratively affect each other until a point of equilibrium (#5 in this graph) is attained. (Note that the control unit may converge to this operating point in real time, as it controls the Vcc, or predetermined points of equilibrium could be programmed into the system, as with the circuit of FIG. 2 in accordance with some embodiments.) Initially, (position 1), the Vcc is at an acceptable operating point, i.e., it is within the two boundaries. Assume, however, that for some reason (e.g., different application that consumes more power, increase in ambient temperature, or change in heat removal conditions such as airflow reduction), the temperature rises, which moves the Vcc/T operating point to position 2. Increase in the device temperature is accompanied with significant additional power increase because both leakage power and dynamic power will increase with temperature. But the control unit lowers the Vcc, to save power, and still operate at an acceptable performance level. With the reduction in power, however, the temperature goes down, which is represented as the transition from position 3 to position 4. With the reduced temperature, the operating point moves out of the acceptable range, with the functional circuit transistors weakening sufficiently to degrade its performance level. Accordingly, the control unit increases the Vcc to move the operating point to position 5, which in this example, is a point of equilibrium.

FIG. 6 shows a portion of a computing system in accordance with some embodiments. It comprises a processing system 601 and a voltage regulator (VR) 611. The processing system, for example, could correspond to a multi-core processor chip. The processor system includes a processor 603, memory 607, and a power control unit (PCU) 609, coupled as shown. The processor 603 has multiple processing cores 606 and a temperature sensor 604 to provide temperature information for the temperature of the transistors within the cores 606. The memory 607 has process parameter information relating to Vcc/T transistor strength relationships for the cores 606. As mentioned above, some processes and/or physical parameters, like transistor frequency can be measured by special circuitry, e.g., ring oscillators, within the processor 603, and then may be used for selecting a Vcc/T curve by control unit 406.

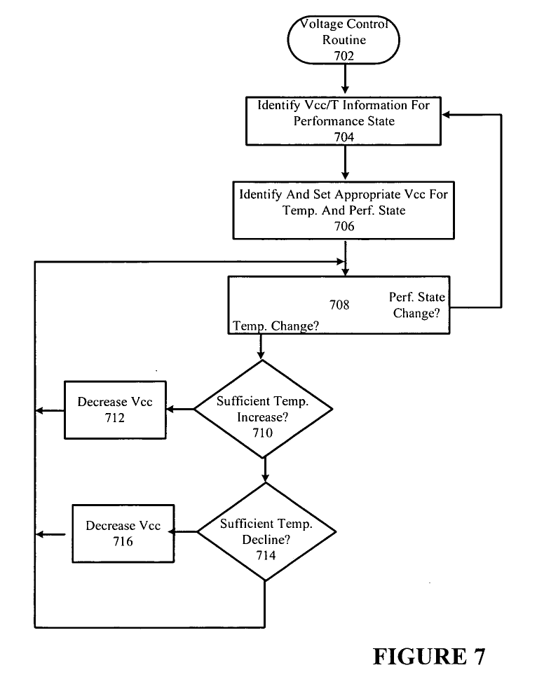

The PCU n609 receives temperature information from temperature sensor 604 and the process parameter information from memory 607 and controls the VR 611 to provide a suitable Vcc to the cores 606. The PCU may do this in any suitable manner such as those already discussed. In some embodiments, it implements a routine such as that shown in FIG. 7.

FIG. 7 shows a voltage control routine 702 for controlling the Vcc of a logic circuit (such as processor cores 606) to reduce active power when the temperature goes up. At 704, it identifies Vcc/T information for the logic at a given performance state. For example, it could identify (e.g., retrieve, select) one or more Vcc/T correlation data sets or it could generate correlations from pre-programmed data. The performance state indicates the required performance level for the logic whose Vcc is being controlled. In some embodiments, the performance state could correspond to a so-called “P” state, as defined by the Advanced Configuration and Power Interface (ACPI). It will typically set an operating frequency for the logic (e.g., processor core) being driven.

Next, at 706, the routine identifies and sets an appropriate Vcc for the performance state based on the temperature. At 708, it monitors for a change in temperature or performance state. If a temperature change occurs, then it proceeds to 710 and determines if a sufficient temperature increase occurred. (The term “sufficiency” or “sufficient,” as used herein, could imply that a small or large change must occur to satisfy the condition. It may simply reflect that real components, even purportedly analog components, generally react in response to “sufficient” changes (albeit they may be very small), or alternatively, the term “sufficient” can mean, for example, that hysteresis is being purposely employed.)

If the temperature increase is sufficient, then from 710 the routine proceeds to 712 and causes the Vcc to decrease and then loops back to 708. If, however, at 710, it was determined that a sufficient temperature increase did not occur, then the routine goes to 714 and determines if a sufficient temperature decrease occurred. If there was a sufficient temperature decrease, then the routine goes to 716, causes Vcc to be increased, and loops back to 708. If a sufficient temperature decrease did not occur, then the routine loops directly back to 708.

Returning back to 708, if a performance state change occurs, then the routine loops back to 704 and identifies (updates) the Vcc/T information for the new performance state. That is, if additional performance is required, then it essentially shifts the Vcc/T function upward, and if less performance is required, then it shifts the function downward.

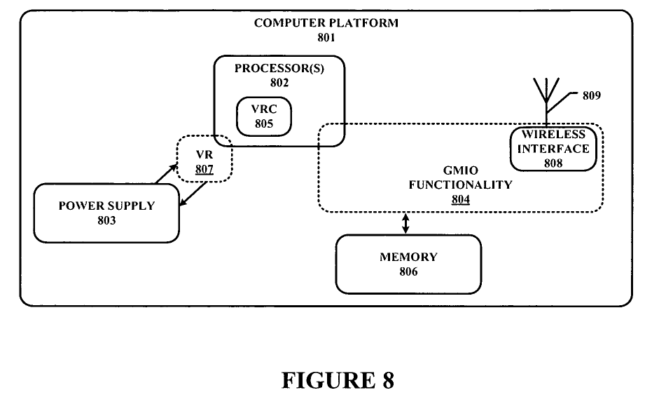

With reference to FIG. 8, one example of a portion of a mobile platform (e.g., computing system 801 such as a mobile personal computer, PDA, cell phone, or the like) is shown. The represented portion comprises one or more processors 802, power supply 803, voltage regulator 807, graphics/Memory/Input/Output (GMIO) interface control functionality 804, memory 806, wireless network interface 808, and an antenna 809. The power supply 803, which may include one or more AC adaptors, batteries, and/or DC-DC voltage regulators, provides DC supplies to the platform components. In particular, it provides a DC supply to VR 807, which is controlled in accordance with approaches discussed herein, by voltage regulator control unit (VRC) 805 to reduce active power consumption in the processor 802.

The processor(s) 802 is coupled to the memory 806 and wireless network interface 808 through the GMIO control functionality 804. The GMIO control functionality may comprise one or more circuit blocks to perform various interface control functions (e.g., memory control, graphics control, I/O interface control, and the like. These circuits may be implemented on one or more separate chips and/or may be partially or wholly implemented within the processor(s) 802.

The memory 806 comprises one or more memory blocks to provide additional random access memory to the processor(s) 802. it may be implemented with any suitable memory including but not limited to dynamic random access memory, static random access memory, flash memory, or the like. The wireless network interface 808 is coupled to the antenna 809 to wirelessly couple the processor(s) 802 to a wireless network (not shown) such as a wireless local area network or a cellular network.

The mobile platform 801 may implement a variety of different computing devices or other appliances with computing capability. Such devices include but are not limited to laptop computers, notebook computers, personal digital assistant devices (PDAs), cellular phones, audio and/or or video media players, and the like. It could constitute one or more complete computing systems or alternatively, it could constitute one or more components useful within a computing system.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The term “PMOS transistor” refers to a P-type metal oxide semiconductor field effect transistor. Likewise, “NMOS transistor” refers to an N-type metal oxide semiconductor field effect transistor. It should be appreciated that whenever the terms: “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs, material types, insulator thicknesses, gate(s) configurations, to mention just a few. Moreover, unless specifically referred to as MOS or the like, the term transistor can include other suitable transistor types, e.g., junction-field-effect transistors, bipolar-junction transistors, metal semiconductor FETs, and various types of three dimensional transistors, MOS or otherwise, known today or not yet developed.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a functional circuit having transistors to implement logic, the transistors to be operated in a temperature range where their strength increases with an increase in temperature; and
a control unit to decrease a voltage supply to the functional circuit when temperature goes up during functional circuit active operation.

2. The chip of claim 1, in which the functional circuit is a processor core.

3. The chip of claim 1, in which the supplied voltage supply is less than 1.0 V.

4. The chip of claim 1, in which the control unit controls the voltage supply in accordance with a data set of Vcc/T correlations.

5. The chip of claim 4, in which the Vcc/T correlations comprise at least one discrete threshold.

6. The chip of claim 4, in which the data set of Vcc/T correlations are based on manufacturing process test results.

7. The chip of claim 4, in which the data set of Vcc/T correlations are programmed into memory accessible to the control unit.

8. The chip of claim 1, in which the supply voltage is controlled in accordance with an acceptable range of voltage versus temperature operating points.

9. The chip of claim 8, in which equilibrium Vcc/T operating points are programmed into a memory to be accessed by the control unit.

10. A method, comprising:
monitoring temperature and performance level for a functional circuit; and
reducing a supply voltage to the functional circuit in an active operating mode in response to the temperature increasing while at least maintaining the desired performance level.

11. The method of claim 10, in which the voltage is reduced in response to the temperature increasing by a sufficient increment.

12. The method of claim 11, in which the functional circuit comprises one or more cores in a processor.

13. The method of claim 12, in which the supply voltage is controlled in accordance with a Vcc/T curve.

14. The method of claim 12, in which the desired performance state is defined by a P state from an operating system.

15. The method of claim 10, in which the supply voltage is controlled to be less than 1 V.

16. A system, comprising:
a chip having a processing core with at least one temperature sensor to monitor an operating temperature; and
a voltage regulator to provide a voltage supply to the core, wherein the chip has a control unit to control the voltage regulator to reduce the voltage supplied to the core in response to the monitored temperature sufficiently increasing.

17. The system of claim 16, in which the chip comprises multiple cores controlled by the control unit to lower their active supply levels when their temperatures sufficiently increase.

18. The system of claim 16, comprising an antenna coupled to the chip to communicatively link it with a wireless network.

19. The system of claim 16, in which the core is formed from transistors made using a 45 nM or smaller process.

20. The system of claim 16, in which the control unit controls the voltage supply in accordance with a data set of Vcc/T correlations.
